(19) United States
(12) Patent Application Publication
(10) Pub. No.: US 2011/0303244 A1
(43) Pub. Date: Dec. 15, 2011

(54) Hydro-Infusion Wet/Dry Debris Containment System Unit and Adapator

(76) Inventor: William A. Faragher, St. Paul, MN (US)

(21) Appl. No.: 13/157,862

(22) Filed: Jun. 10, 2011

Related U.S. Application Data
(60) Provisional application No. 61/353,448, filed on Jun. 10, 2010.
(60) Provisional application No. 61/408,716, filed on Nov. 1, 2010.

(51) Int. Cl. A47L 7/00; B08B 5/04

(52) U.S. Cl. 134/21; 15/347

(57) ABSTRACT

A hydro-infusion wet/dry debris containment system unit and an adaptor are described. The unit comprises at least one canister, debris intake system, filter, tank, electric motor assembly, fill port, and exhaust port. The unit further comprises an ionic generator. The adaptor comprises at least one debris intake system and reservoir. The debris intake system comprises a debris inlet port, an expansion chamber, a fluid collar, a fluid inlet, and a debris outlet port. The fluid collar comprises a plurality of orifices that generate a curtain of water. The fluid inlet comprises at least one regulator. Debris sucked into the debris inlet port is lifted by a venturi effect caused by airflow across the smoothly varying inner diameter of the inlet port lumen wall and expands in the expansion chamber as it flows through the fluid collar and particulates are encapsulated by the curtain of water.

### RELATED APPLICATIONS

This application claims priority to U.S. Provisional Application Ser. No. 61/353,448 filed with the United States Patent and Trademark Office on Jun. 10, 2010, and U.S. Provisional Application Ser. No. 61/408,716 filed with the United States Patent and Trademark Office on Nov. 1, 2010, both of which are incorporated herein by reference in their entirety.

### FIELD OF THE INVENTION

The invention generally relates to a hydro-infusion wet/dry debris containment system unit and adaptor. More specifically, the invention is a hydro-infusion wet/dry debris containment system unit and adaptor that incorporates the use of water in the filtration of fine particles.

### BACKGROUND

There is a need for a hydro-infusion wet/dry debris containment system unit and adaptor that, through the use of water or other fluid, is able to filter out fine particulates as well as to pick up larger pieces of debris. Debris containment systems generally operate by picking up pieces of debris through an intake hose with the use of a motor that creates a vacuum. The flow of air creates a path for the airflow from the intake through the canister and out an exhaust outlet. Along the path of the airflow, most vacuums or wet/dry vacuums place a filter or a series of filters in the airflow path where the debris will be caught, and only the air will exit the system. However, the problem with most of these systems is that the filters are clogged easily and also fail to capture fine particulates. These fine particulates are particulates, such as dry wall dust. After vacuuming up, for example, dry wall dust, most vacuums, when they are turned back on, blow a cloud of fine dry wall dust back out into the environment.

### SUMMARY OF THE INVENTION

In one embodiment of the hydro-infusion wet/dry debris containment system unit and adaptor, the unit and adaptor are part of one embodiment. In one embodiment, the hydro-fusion wet/dry debris containment system unit is a separate embodiment. In another embodiment, the hydro-infusion wet/dry debris containment system adaptor may be a separate embodiment. In one embodiment, the adaptor may be connected, coupled to, or engaged with existing debris containment devices, like a wet-vac. For clarity, the term “unit” refers to the hydro-fusion wet/dry debris containment system unit, and the term “adaptor” refers to the hydro-fusion wet/dry debris containment system adaptor.

In one embodiment of the unit, the unit comprises at least a base, a canister, a debris intake system, an exhaust port, a filter, and a housing encompassing mechanical components. In one embodiment, the base can be a flat surface, wherein the top surface of the base can be affixed to the canister and the bottom surface of the base can have a plurality of wheels attached thereto. An advantage of affixing the base to the canister is to provide additional stability to the unit, as well as the incorporation of a plurality of wheels enables the user to easily maneuver the unit. The wheels used can be of any variety, including wheels made of all plastic, plastic and metal, metal and rubber, or any combination thereof, locking wheels, bi-directional wheels, and the like.

In another embodiment, the base can be attached to the unit in such a way that it may be detachable. The base and canister can be attached in a variety of ways, including fasteners, clips, latches, hinges, and any other means wherein the base and canister can be attachable and/or detachable. Advantages of having the base detachable include the ability for the user to clean between the pieces, as well as allowing the user to add additional fluid tanks, as described more fully below.

In a further embodiment, the base can be more than merely a hard surface to attach to the canister and have wheels attached thereto. In one embodiment, the base may comprise compartments, drawers, additional inlet/outlet ports, electrical outlets, and the like. The base can be made out of a hard plastic, durable metal, or any combination thereof, or any other suitable type of material.

In one embodiment of the unit, the canister comprises at least a top portion and a bottom portion. In one embodiment, the top and bottom portions are part of the same piece, wherein while these portions may be manufactured separately, they are coupled together in such a way that the user is unable to separate them. In another embodiment, the top and bottom portions are two separate pieces, wherein the portions may be coupled by way of hinges, latches, clips, fasteners, springs, and any other means in which the portions may be attached together. The detachability of these portions would allow easy access to the internal workings and parts of the unit, as well as removal of collected debris. The canister can be made out of plastic, such as a hard plastic, for example, PVC, and other lightweight and durable materials.

In one embodiment of the top portion of the unit, the top portion comprises at least an exhaust port, a filter, a housing encompassing mechanical components, and a debris intake system. In one embodiment, the exhaust port can be located in the center of the top surface of the top portion, wherein the air exiting the unit would leave through this port and enter back into the environment. In one embodiment, a filter may be situated within the exhaust port, such that right before the airflow re-enters the environment, it will pass through a filter. An advantage of this additional filter is to provide yet another means for capturing particulates that have managed to get through the unit without capture. The filter can be any variety of filters available, such as hepa filters, paper filters, and the like.

In one embodiment of the top portion, the top portion can include a housing, which encompasses mechanical components. The mechanical components encompassed in the housing comprise at least a fan, a motor, wires, connectors, and other related electro-mechanical parts used in powering the unit as well as providing for the suction of air through the unit. The housing may be protected by a shield, such that when the top portion is detached from the bottom portion, the internal components in the housing are not fully exposed. Rather, the shield would need to be removed or detached to allow the user access to the housing's internal components. An advantage of the shield is to protect the user, as well as protect the internal components from damage from the user, debris, water, and the like. Additionally, the housing can be waterproof.

In one embodiment of the top portion, the top portion includes a filter such that the filter can be disposed such that the airflow will pass through the filter before entering the exhaust port and re-entering the environment. Any type of filter can be used, such as a hepa filter, paper filter and any other type of filter used for the capture of fine particulates.

In another embodiment of the unit, the unit can also include an ionic generator, wherein the ionic generator can be located within the top portion of the canister. In another embodiment, the unit may include a passive ion generator, wherein the generator fits inside the cartridge filter and has concentric rings of dissimilar metal screens attached to an anode metallic base. A metallic collar may be insulated between the metal screens and the cartridge filter connecting post and grounded to the electric motor. Any particulates that are not removed from the debris path by the fluid infusion, pass through the ionic generator receiving a positive charge and are likely attracted to the grounded collar, maximizing efficiency. In one embodiment, the user can decide whether or not to use the passive ionic generator by turning on a switch, such that the use of the ionic generator is optional. In another embodiment, the ionic generator is operational whenever the unit is also operational.

In one embodiment of the top portion, the top portion includes a debris intake system. In one embodiment of the debris intake system, the system comprises at least a debris inlet port, an expansion chamber, a fluid collar, a fluid inlet, and a debris outlet port. The term “fluid collar” describes a collar structure, for example, a tubular collar structure, wherein a fluid flows through the lumen of the tubular collar structure, and the term “fluid inlet” describes an inlet for fluids; through which fluids can pass. In one embodiment of the debris intake system, the system components are affixed such that the user is unable to detach or separate the different components. In another embodiment, the components can be detachable from some or all of the other components. In one embodiment, the debris intake port and the expansion chamber are contained within the same housing. In one embodiment, the fluid collar can also be contained within the same housing. In another embodiment, the fluid collar can be a separate piece that is in communication with the expansion chamber.

In one embodiment, the debris inlet port consists of an entrance or proximate end, and intermediate section, an exit or distal end, and a lumen therethrough. The entrance, or proximate end, is where a vacuum hose can be engaged with the unit such that the debris flows through the hose, through the entrance, and into the debris intake port. In one embodiment, the exit, or distal end, includes an orifice that has a smaller diameter than that of the entrance and opens into the expansion chamber. In one embodiment, the lumen is such that it narrows as the distal end is approached, such that the internal surface of the lumen slopes or curves toward the orifice.

In one embodiment, the expansion chamber has an entrance, an exit and a body. The entrance abuts the exit orifice of the debris inlet port such that the debris flows through the exit orifice and into the expansion chamber. In one embodiment, the expansion chamber body is in communication with the fluid collar, as discussed in more detail below. In another embodiment, the fluid collar is attached, integral, or a part of the body of the expansion chamber.

In one embodiment, the fluid inlet comprises at least a top or proximate end, a bottom or distal end, a body and a regulator. The top of the fluid inlet is in communication with the fluid collar. The bottom of the fluid inlet is in communication with a fluid tank, as discussed in more detail below. The body of the fluid inlet includes a lumen allowing for the passage of fluid from the fluid tank into the fluid collar. In one embodiment, the body includes a tube that extends from inside the fluid tank, through the fluid inlet and into the fluid collar. In one embodiment, a regulator is engaged with the body of the fluid inlet, such that the regulator provides the user with a means for regulating the flow rate of the fluid from the fluid tank into the fluid collar. The regulator can be a type of screw, wherein as the user turns the screw head clockwise, the body of the screw extends into the lumen of the fluid inlet body or, alternatively, into the tube in the fluid inlet body, restricting the flow rate, or the screw head can be turned counter-clockwise to increase the flow rate. The regulator can also be a spring pin, a valve, and the like. In one embodiment, the bottom of the fluid inlet can comprise a cap-like structure that has female threading, such that the top of a bottle or other container consisting of male threading can be screwed/twisted into the bottom of the fluid inlet.

In one embodiment, a fluid collar comprises at least an outside surface and an inside surface. The collar is a tube-like structure that circumferentially wraps around the expansion chamber. In one embodiment, the outside surface comprises at least one opening such that the collar is in communication with the fluid inlet, wherein as the fluid flows through the fluid inlet it enters into the fluid collar through the opening. The inside surface comprises a plurality of orifices, creating fluid jets when a fluid, for example, water, is coursing through the fluid collar lumen. Alternatively, the inside surface can comprise a plurality of nozzles, the nozzles capable of producing jets of fluid. Where the collar is part of, or integral to, the expansion chamber, the orifices open directly into the expansion chamber. In another embodiment, where the collar is a separate piece, the orifices of the collar may align directly with mirroring orifices in the expansion chamber, such that the collar and the expansion chamber are in direct communication.

In one embodiment, the debris outlet comprises at least an entrance or proximal end, an end or distal end, a body, and a back plate. In one embodiment, the entrance, or proximate end, abuts the expansion chamber's exit, such that as the debris exits the expansion chamber it moves into the debris outlet entrance. The end of the debris outlet is attached to a back plate, such that the back plate extends beyond the outlet end, or distal end, and into the debris chamber of the canister. In one embodiment, the debris outlet body comprises a cutout and/or opening, such that the opening creates an exit for the airflow and debris to move from the debris outlet and into the debris chamber.

An advantage of the unit is the use of the venturi effect in combination with the unit's different components such that particulates may be captured/encapsulated and thus removed from the air flow so that they may not be returned back into the environment and/or clog up additional filters. As the debris flows into the debris inlet, the debris is lifted to the center of the inlet lumen as the internal surface of the debris inlet slopes or curves toward the exit orifice. This is unlike most vacuums wherein the debris is usually found on the gravity side of the hose. Due to the venturi effect, the pressure before the orifice is greater and the velocity is lower, whereas the pressure is less and the velocity is greater on the other side of the orifice leading into the expansion chamber. This causes the debris to separate in an organized disorganized way within the expansion chamber, such that more particulates are encapsulated by the fluid. Another advantage is the use of the unit's power and suction in pulling up the fluid from the tank, through the fluid inlet, into the fluid collar, and out the plurality of orifices. The plurality of orifices creates burbling within the fluid such that it is sprayed out in droplets, which aids in the capture and encapsulation of particulates. The plurality of orifices also provides 360 degrees of fluid being sprayed onto the debris, enabling the capture of more particulates with the fluid and the removal of them from the debris flow before they reach the filter and exhaust port.

In one embodiment, the bottom portion of the canister comprises at least a fluid tank, a debris chamber, and a fluid fill port. In one embodiment, the tank is located in the bottom section of the bottom portion, such that the bottom surface of the tank is also the bottom surface of the canister. In one embodiment, the debris chamber is located just above the tank, wherein the bottom surface of the debris chamber is the top surface of the tank. In one embodiment, there is no communication between the tank and the debris chamber. In another embodiment, there may be communication between the tank and debris chamber. Communication can be achieved by the use of a valve, a protrusion and cover, such that a portion of the tank protrudes into the debris chamber and resembles a bottle neck including male threading, wherein a cover including female threading can be twisted or otherwise secured onto the protrusion. Other such similar means for providing communication between the tank and the debris chamber are contemplated.

In one embodiment of the bottom portion, the fluid fill port may be a tube that extends vertically from the inside of the tank, through the debris chamber, and exiting through the outside surface of the canister. The fluid fill port may be positioned such that it runs along the inside surface of the canister before exiting through an opening in the outer surface, for example, through a side wall of the bottom portion, of the canister, wherein a portion of the fluid fill port extends beyond the canister wall, for example, extends from the exterior of the canister; an “outside end”.

In one embodiment, the outside end of the fluid fill port may include a cover and a means for attaching the same. For example, the outside end may have male threads and the cover may have female threads such that the cover can be screwed onto the fluid fill port outside end. In another embodiment, the cover may snap onto the outside end by the use of an indent. Other such similar ways of covering the outside end of the fluid fill port are contemplated. In another embodiment, the cover may have at least one vent.

In another embodiment, the unit may have more than one tank. In one embodiment, the tanks may be separate from the unit, wherein a user can add additional tanks or remove tanks as desired. In another embodiment, the tanks may be permanently attached. In one embodiment, the tanks may be in communication with each other, wherein the user may push on a button, lever or the like, and the contents of one tank empty into another tank. An advantage of this configuration allows the user to collect more debris, wet or dry. Another advantage allows the user to start with the collection of fluid debris, empty into a lower tank, and then switch to collecting dry debris in an upper tank.

Another advantage of multiple tanks is that it allows the user to drain debris from the debris chamber into the upper tank while the vacuum is still running, by the push of a button. In one embodiment, the unit can contain a push button, or other actuator, which is operatively connected to a push rod and a trap door, wherein the user pushes on the button, which engages with the push rod causing the trap door to open. When the vacuum is still on, this creates an additional suction wherein the contents of the debris chamber are sucked into the upper tank.

In another embodiment, the bottom portion may include at least one spigot in communication with the tank. In another embodiment, there may be a plurality of spigots such that each is in communication with a different tank. In another embodiment, instead of a spigot, a valve, opening, and the like may be used. An advantage of incorporating a spigot and the like is to provide the user with an easy means for emptying the tank(s).

In one embodiment, the canister may contain at least one window. For example, there may be a view window associated with the fluid tank providing the user a way of viewing the fluid level in the tank. There may be a view window associated with the debris chamber, wherein the user may easily view the level or amount of debris that has been collected. If there are additional tanks, those tanks may also contain view windows.

In one embodiment, the hydro-infusion wet/dry debris containment system adaptor is an adaptor that can be universally adapted to all or most all wet/dry canister-type vacuums. In one embodiment, the adaptor can provide a pretreatment to the debris stream to bind and coagulate dust, debris, and contaminates. The condensed debris may be collected in the debris chamber of the vacuum to which the adaptor was connected.

In one embodiment, the adaptor comprises at least a debris inlet, an expansion chamber, a fluid inlet, a fluid collar, and a debris outlet. The adaptor may be made out of a hard plastic, or any other lightweight and durable material.

In one embodiment, the debris inlet consists of an entrance or proximate end, an intermediate section, an exit or distal end, and a lumen therethrough. The entrance, or proximate end, is where a vacuum hose engages with the adaptor such that the debris flows through the hose and into the adaptor. In one embodiment, the exit, or distal end, consists of an orifice that has a smaller diameter than that of the entrance and opens into the expansion chamber. In one embodiment, the lumen is such that it narrows between the entrance and the exit, wherein the internal surface of the lumen, as it approaches the exit orifice, slopes or curves toward the orifice.

In one embodiment, the expansion chamber has an entrance, an exit and a body. The expansion chamber entrance abuts the exit orifice of the debris inlet such that the debris flows through the exit orifice and into the expansion chamber. In one embodiment, the expansion chamber exit abuts the debris outlet, such that as the air flow and debris exit the expansion chamber they are carried into the debris outlet. In one embodiment, the body is a tubular member and in communication with the fluid collar, as discussed in more detail below. In another embodiment, the fluid collar is attached or integral to the body of the expansion chamber.

In one embodiment, the fluid inlet comprises at least of a top or proximate end, a bottom or distal end, a body and a regulator. The top of the fluid inlet is in communication with the fluid collar. The bottom of the fluid inlet is in communication with a reservoir. The body includes a lumen allowing for the passage of fluid from the reservoir into the fluid collar. In one embodiment, the body includes a tube that extends from inside the reservoir, through the fluid inlet and into the fluid collar. In one embodiment, a regulator is engaged with the body of the fluid inlet, such that the regulator provides the user with a means for regulating the flow rate of the fluid from the reservoir into the fluid collar. The regulator can be a type of screw, wherein as the user turns the screw head clockwise, the body of the screw extends into the lumen restricting the flow rate or, when the screw head is turned counter-clockwise, the flow rate is increased. The regulator can also be a spring pin, a valve, and the like. In one embodiment, the bottom may comprise a cap-like structure, such that it has female threading such that the top of a bottle or other container, having male threading, can be screwed/twisted into the bottom of the fluid inlet.

In one embodiment, a fluid collar comprises at least an outside surface, a lumen, and an inside surface. The collar is a tubular structure that circumferentially wraps around the expansion chamber. In one embodiment, the outside surface of the collar comprises at least one opening such that the collar is in communication with the fluid inlet, wherein as the fluid flows through the fluid inlet it enters into the fluid collar through the opening. The inside surface comprises a plurality of orifices, creating fluid jets when a fluid, for example water, is coursing through the fluid collar lumen. Alternatively, the inside surface can comprise a plurality of nozzles, the nozzles capable of producing jets of fluid. Where the collar is part of the expansion chamber, the orifices open directly into the expansion chamber. In another embodiment, where the collar is a separate piece, the orifices of the collar may align directly with mirroring orifices in the expansion chamber, such that the collar and the expansion chamber are in direct communication.

In one embodiment, the debris outlet comprises at least an entrance, an exit and a body. In one embodiment, the entrance, or proximate end, abuts the expansion chamber's exit, such that as the debris exits the expansion chamber it moves into the debris outlet. The debris outlet exit, or distal end, may be engaged with a vacuum intake. In another embodiment, the debris outlet exit engages with a vacuum hose such that the vacuum hose is engaged with a vacuum intake. In one embodiment, the body of the debris outlet may have a view window such that the user can view the debris as it passes through the debris outlet. An advantage of the view window is that it aids the user in determining whether the flow rate needs to be adjusted.

An advantage of the adaptor is the use of the venturi effect in combination with the adaptor's different components such that particulates may be captured/encapsulated and thus removed from the airflow so that they may not be returned back into the environment. As the debris flows into the debris inlet, the debris is lifted to about the center of the inlet as the internal surface of the debris inlet slopes or curves toward the exit orifice. This is unlike most vacuums wherein the debris is usually found on the gravity side of the hose. Due to the venturi effect, the pressure before the orifice is greater and the velocity is lower, whereas the pressure is less and the velocity is greater on the other side of the orifice leading into the expansion chamber. This causes the debris to separate in an organized disorganized way, such that more particulates are encapsulated by the fluid. Another advantage is the use of the unit's power and suction in pulling up the fluid from the reservoir, through the inlet port, into the fluid collar, and out the plurality of orifices. The plurality of orifices creates burbling within the fluid such that the fluid is sprayed out in droplets, which aids in the capture and encapsulation of particulates. The plurality of orifices also provides 360 degrees of fluid being sprayed onto the debris, enabling the user to capture more particulates with the fluid and remove them from the debris flow before they reach the filter and exhaust port.

In one embodiment of the unit and adaptor, instead of water being used as the fluid, the user may use soap, antifungal fluid, anti-bacterial fluid, or other fluid-type substance to pre-treat and/or treat the debris being collected. For example, if the debris was something biological, the fluid could be some type of disinfectant that would treat the debris being collected, as well as possibly encapsulate the particulates associated with such biological debris.

The above summary of the various aspects of the invention is not intended to describe each embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE DRAWINGS

These as well as other objects and advantages of this fluid-infusion wet/dry debris containment system and adaptor will be more completely understood and appreciated by referring to the following more detailed description of the exemplary embodiments of the invention in conjunction with the accompanying drawings of which:

FIG. 1 is a perspective view of an embodiment of a hydro-infusion wet/dry debris containment system unit;

FIG. 2 is an enlarged perspective view of a portion of an embodiment of a hydro-infusion wet/dry containment system unit depicting an embodiment of an intake system;

FIG. 3 is a perspective view of an embodiment of a hydro-infusion wet/dry containment system adaptor;

FIG. 4 is a perspective view of an embodiment of a hydro-infusion wet/dry debris containment system unit, including an ionic generator and multiple tanks; and

FIG. 5 is a perspective view of an embodiment of a hydro-infusion wet/dry debris containment system unit, including an ionic generator.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives.

### DETAILED DESCRIPTION

The several embodiments as shown in the figures allow the user of the fluid-infusion wet/dry debris containment system unit and adaptor to have multiple choices to certain features and subcombinations of each embodiment, as there are several choices available relating to the several embodiments. Advantages and embodiments of this invention are further illustrated by the following examples, but the particular materials and amounts thereof recited in these examples, as well as other conditions and details, should not be construed to unduly limit this invention.

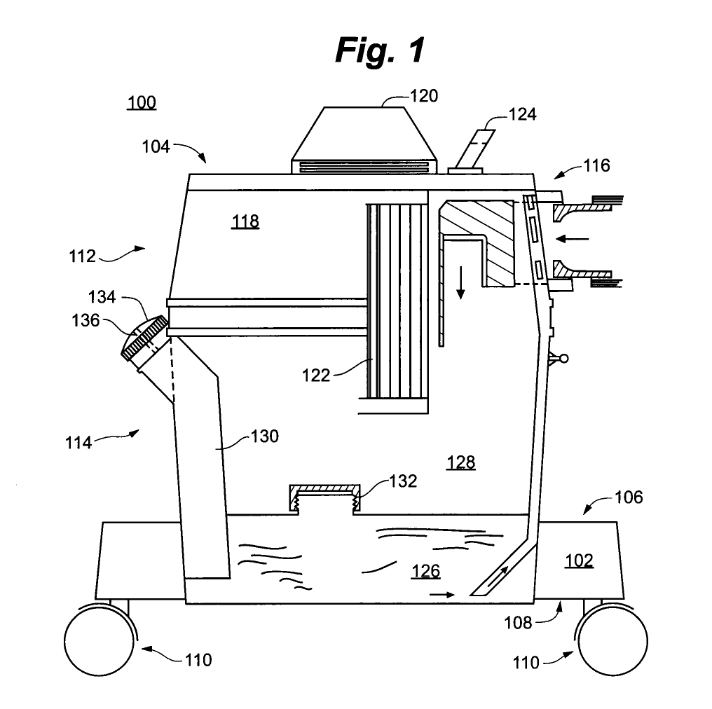

FIG. 1 is a perspective view of an embodiment of a hydro-infusion wet/dry debris containment system unit 100. The unit 100 comprises of at least a base 102 and a canister 104. The base 102 can include a top surface 106 and a bottom surface 108, wherein the top surface 106 is attached to the canister 104. The bottom surface 108 can include a plurality of wheels 110 or other means of transport for easily moving the unit 100 along the ground or other surface.

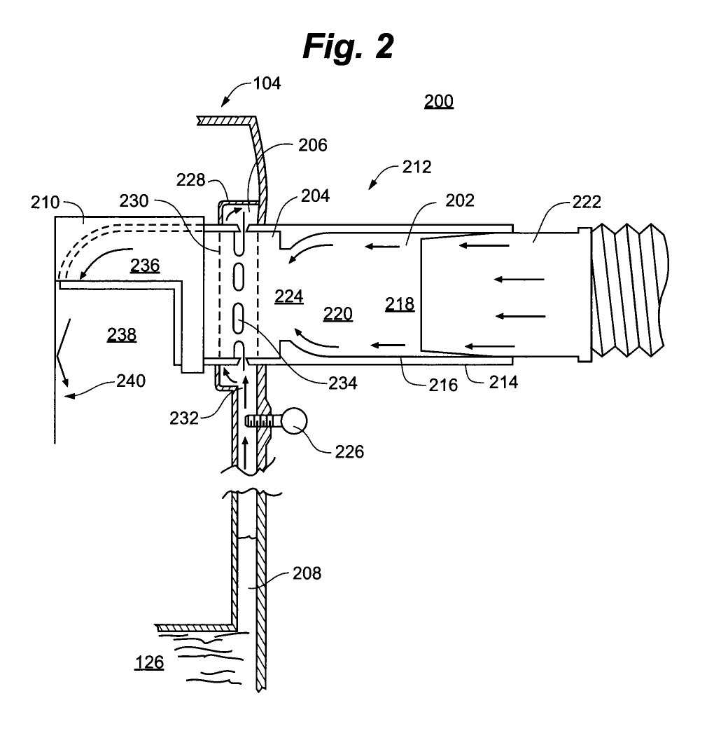

The canister 104 can comprise an upper portion 112 and a lower portion 114. The upper portion 112 and the lower portion 114 of the canister 104 can be separate pieces, wherein the portions may be attached to each other, for example by clips, latches, hinges, and the like. Alternatively, the portions 112, 114 can be part of one integral piece. The upper portion 112 can include a debris intake system 116, a housing for mechanical elements 118, an exhaust port 120, and at least one filter 122. The debris intake system 116 and its various features and structures are more fully described below in FIG. 2. The housing 118 can encompass a motor, a fan, and related electro-mechanical parts used in the operation of providing power to and running the vacuum, including an on/off switch 124. The exhaust port 120 can be proximately placed above the fan, wherein the air, after being sucked through the canister 104, is expelled back into the environment. The at least one filter 122 can be a paper filter, hepa filter, and the like, wherein the flow of air as it passes through the canister 104 from the debris intake system 112 to the exhaust port 120 must pass through the filter 122.

The lower portion 114 of the canister 104 can comprise at least a fluid tank 126, a debris chamber 128, and a fluid fill port 130. The tank 126 can be disposed in the bottom section of the lower portion 114 of the canister 104, wherein the tank 126 can be used to contain fluid. The debris chamber 128 can be disposed in the top section of the lower portion 114 of the canister 104, such that the chamber 128 is directly above the tank 126. There may be no communication between the chamber 128 and the tank 126. Alternatively, for cleaning purposes, venting purposes and the like, a communication port 132 can allow the tank 126 to be in communication with the chamber 128. For example, the communication port 132 can be a protrusion and cover, such that the protrusion includes male threading wherein the cover includes female threading such that the cover can be screwed/twisted onto the protrusion. The communication port 132 can also be a valve and the like.

The fluid fill port 130 can be a tubular member, which can extend from outside of the canister 104 into the tank 126. The external portion of the fill port 130 can include a cover 134, wherein the cover 134 is actively engaged with the fill port 130. For example, the external end of the fill port 130 can have male threading and the cover 134 can have female threading, wherein the cover 134 can be screwed onto the fill port 130. Alternatively, the cover 134 can be a type of snap-on structure or the like. The cover 134 can also include an opening or vent 136 to equalize the pressure in the tank 126 as the fluid level decreases.

FIG. 2 is an enlarged, cross-sectional perspective view of an embodiment of a unit depicting a debris intake system 200. The intake system 200 can comprise a debris inlet port 202, an expansion chamber 204, a fluid collar 206, a fluid inlet 208, and a debris outlet port 210. The intake system 200 components can be one piece or can be separate pieces that are attached to each other. In the embodiment shown, the debris inlet port 202 and the expansion chamber 204 are abuttingly disposed within an inlet housing 212. The inlet housing 212 comprises an external surface 214 and an internal surface 216. The external diameter of the inlet housing 212 can be uniform along the entire length of the inlet housing 212. The internal surface 216 of the inlet housing 212 can comprise two sections relating to the inlet port 202 and the expansion chamber 204.

The inlet port 202 can comprise a first section or proximate end 218, a second or distal section 220, an intermediate section therebetween, and a lumen therethrough. The first section or proximate end 218 can have a continuous, uniform inner diameter that is large enough to allow entry and engagement of a vacuum hose collar 222. The second section or distal end 220 can comprise a length of the inlet port 202, wherein the inner diameter of the inlet port 202 begins decreasing, sloping or curving toward an orifice 224, which orifice 224 has a smaller diameter than the inlet port 202 opening. The expansion chamber 204 can be located on the other side of the orifice 224, wherein the inner diameter of the expansion chamber 204 is greater than the diameter of the orifice 224. In one alternative, the expansion chamber's 204 inner diameter is the same as the inlet port's 202 inner diameter.

The expansion chamber 204 can be encircled by a fluid collar 206. The fluid collar 206 is in direct communication with the canister's 104 fluid tank 126, wherein the canister 104 can include a fluid inlet 208, which can be a tubular member that extends from the tank 126 to the collar 206. Alternatively, a tube or other similar structure can be used to connect the collar 206 to the tank 126. A regulator 226 can be in communication with the fluid inlet 208 so as to regulate or otherwise vary or adjust the flow of fluid from the tank 126 to the collar 206. The regulator 226 can be in the form of a screw, valve, or other device that provides the user with a way of adjusting the fluid flow rate through the inlet port 208 and into the collar 206. For example, the regulator 226 can be a screw that, as it is rotated, more and more of the screw is impeding into the fluid inlet 208.

The collar 206 can comprise an external surface 228 and an internal surface 230. The external surface 228 can include an aperture 232 through which the fluid from the tank 126 can flow into the collar 206. The internal surface 230 of the collar 206 can comprise a plurality of orifices 234, wherein the orifices are arranged to encircle the expansion chamber 204, which expansion chamber 204 can be disposed in an inlet housing 212 in communication with the inlet port 202, such that when fluid is pulled up from the tank 126, it is transported into the collar 206 where it is then expelled through the orifices 234, or alternatively, though nozzles.

The debris outlet port 210 can comprise a shield 236, an opening 238, and a back plate 240. The shield 236 can comprise a piece of hard plastic, or any other lightweight and durable material, and extends horizontally from the top of the inlet housing 212 to the back plate 240. The shield 236 can comprise an opening 238, wherein the opening 238 allows for the path of debris to travel from the inlet port 202 and expansion chamber 204 through the outlet port 210 through the opening 238 toward the back plate 240 and into the debris chamber 128. The back plate 240 can be made of a rubber or rubber-type of material or any other type of flexible material that may have some surface friction. The back plate 242 can be flexible.

An advantage of the unit is the creation and use of the venturi effect. In operation, the debris enters the inlet port 202 through a vacuum hose 222. The debris path flows from the debris inlet port 202, wherein the pressure is increasing as the velocity is decreasing, and due to the sloping or curving lumen within the inlet port 202, causing the debris to be lifted to about the center of the airflow path. The debris then passes through the orifice 224 and into the expansion chamber 204 of the inlet housing 212, wherein the pressure decreases and the velocity increases, causing the debris to separate into more distinct particles. The debris flow path carries the separated debris through the fluid collar 206, where fluid is expelled from the 360-degree circumferential fluid collar 206 by a plurality of orifices 234 such that the debris is showered with fluid from all, or substantially all, directions. An advantage of showering the debris with fluid from all directions is the ability to surround, capture or otherwise encapsulate fine particulates with the fluid droplets, wherein these particulates are contained within the fluid and in the canister 104, and thus are removed from the airflow and exhaust. Another advantage is the use of the vacuum to pull the fluid into the fluid collar 206 which causes the fluid to burble, such that in combination with the orifices 234, the water is separated into droplets, which can then encapsulate tiny particulates in the airflow. Another advantage is the user's ability to regulate the fluid, which may depend on the type of debris and the type of fluid being used. For example, where the debris may be covered in mold, the user may want more fluid, and a fluid such as an anti-fungal or similar fluid, to ensure a generous coating of bigger pieces as well as the encapsulation of smaller particulates.

The airflow then carries the debris into the outlet port 210. The shield 236 directs the airflow downward toward the opening 238 of the outlet port 210 and the back plate 240. The back plate 240 aids in the capture and encapsulation of particulates in the air flow. The back plate 240 allows for the accumulation of debris on the back plate 240, thus keeping the debris from flowing to and clogging the paper filter. In addition, the back plate 240 flexibility encourages the debris to accumulate on the back plate 240, so it will fall off the back plate 240 and into the debris chamber 128.

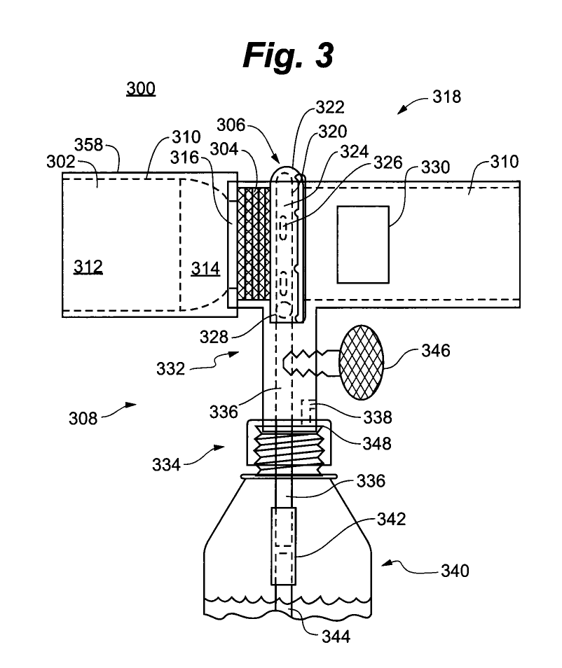

FIG. 3 is a perspective view of an embodiment of an adaptor 300. The adaptor 300 can be T-shaped comprising at least a debris inlet port 302, an expansion chamber 304, a fluid collar 306, a fluid inlet port 308, and an outlet port 310. The adaptor 300 can be designed to include other or additional ports. The adaptor 300 can be one solid piece or it can be separate pieces. The adaptor 300 can be made out of a hard plastic, such as PVC, for lightness and durability, or other similar material or combination of materials.

The debris inlet port 302 can have an external surface 308 and an internal surface 310. The inlet port 302 can have a consistent/uniform outside diameter that extends the length of the inlet port 302. The inlet port 302 can have a varying internal diameter. For example, the inlet port 302 can comprise three sections: a first or proximate section 312, a second or intermediate section 314, and third or distal section 316, with a lumen therethrough. The first section 312 can have an internal diameter that allows the insertion of a vacuum hose into the inlet port 302, wherein the hose fits snuggly inside the first section 312. The second section 314 of the inlet port 302 can have an internal diameter that decreases as the third section 316 is approached, wherein the internal surface 310 begins to slope or curve toward the third section 316. The third section 316 of the inlet port 302 can have the smallest diameter, thereby creating an orifice the debris flow passes through before entering the expansion chamber 304.

The expansion chamber 304, the fluid collar 306, and the outlet port 310 can all be separate sections or pieces disposed within an outlet housing 318. The outlet housing 318 can have an outer diameter that is the same, greater, or less than the outer diameter of the debris inlet port 302. The outlet housing's 318 outer diameter can be uniform over the entire length of the outlet housing 318 or it may vary. The expansion chamber 304, which can be the first section within the outlet housing 318, has an internal diameter that is greater than the diameter of the orifice of section 316 of the inlet port 302. The debris path flows from section 316 of the debris inlet port 302 directly into the expansion chamber 304.

The fluid collar 306, which can be the second section of the outlet housing 318, can comprise a tubular member comprising an internal surface 320, an external surface 322, and a lumen 324. The internal surface 320 of the collar includes a plurality of orifices 326 that are spaced apart along the entire circumference of the internal surface 320. The external surface 322 of the collar 306 can include an aperture 328, wherein the aperture 328 may be in communication with the fluid inlet port 308, as described more fully below. The outlet port 310, which can be the third section within the outlet housing 318, can be operatively connected to the intake of a user's vacuum cleaner. The outlet port's 310 connection to the vacuum's intake can be either directly engaged with the vacuum's intake or indirectly engaged with a vacuum's intake through the use of additional vacuum hoses or the like. The outlet housing 318 can include a view window 330, wherein the view widow 330 can be made of a transparent material, such as a hard plastic, for example, plexi-glass or the like.

The fluid inlet port 308 can be operatively connected to the outlet housing 318 and more specifically in the area of the fluid collar 306. The fluid inlet port 308 can include a first section 332 and a second section 334. The first section 332 extends between the outlet housing 318 and the second section 334. The first section 332 can comprise a uniform outer diameter extending the length of the first section 332. The first section 332 can comprise at least a first lumen 336 extending the length of the first section 332. The first section 332 can also comprise a second lumen 338 that extends upwardly from the second section 334 and then turns 90 degrees to extend to the outer surface of the first section 332. The first lumen 336 can be used to transport fluid from the reservoir 340, as discussed below, into the fluid collar 306 through the aperture 328. The second lumen 338 can be used as a vent to equalize the pressure within the reservoir as the fluid is being sucked up into the fluid collar 306 by the user's vacuum.

Alternatively, the first section 332 can be a tubular member with a uniform internal diameter defining a lumen, such that at least one other tube or tubular structure can fit within the lumen. The first section 332 can include a transfer tube 336, which can extend from the collar's 306 aperture 328 through the inlet port 308 and extending beyond the inlet port 308, such that the transport tube 336 can extend into the reservoir 340, as described more fully below. The transfer tube 336 can be of a predetermined length wherein a coupling device 342 can be used to attach another tubular member 344, such that the transfer tube 336 is operationally submerged within the reservoir 340. The additional tubing 344 can be of varying lengths, wherein the piece used may be determined by the size of the reservoir 340 being used. The first section 332 can include a vent tube 338, which can be of the shape of an upside-down L that extends from the outer surface of the first section 332 inwardly and horizontally and then downwardly into the second section 334, such that the tube 338 will terminate within the opening of the second section 334 and the reservoir 340 opening or just beyond.

The first section 332 can include a regulator 346, wherein the regulator 346 can be in the form of a screw, valve, or other device that provides the user with a way of adjusting the fluid flow rate through the inlet port 308 and into the collar 306 of the outlet housing 318. For example, the regulator 344 can be a screw that, as it is rotated, more and more of the screw is extending into the first lumen, or transport tube, 336. The second portion 334 of the inlet port 308 can be of the form of a female threaded receiver, and a reservoir 340, such as a plastic bottle or other similarly sized or shaped container with a male threaded top can be coupled with the receiver of the second portion 334 of the inlet port 308. A washer 348 can be incorporated between the top of the reservoir 340 and the inside of the threaded receiver to create a seal and prevent leaking of the fluid at the point of connection.

An advantage of this system is the creation and use of the venturi effect. In operation, the debris enters the adaptor 300 through the inlet port 302. The debris path flows from the first section 312 into the middle section 314, wherein the pressure is increasing as the velocity is decreasing, and the internal diameter of the inlet port 302 is decreasing as the internal surface of the inlet port 302 is sloping or curving toward the third section 316, causing the debris to be lifted to about the center of the air path in the inlet port 302. The debris then passes through the third section 316 into the expansion chamber 304, wherein the pressure decreases and the velocity increases, causing the debris to separate. The debris path carries the separated debris through the fluid collar 306 where fluid is expelled from a plurality of orifices 326 such that the debris particulates are showered with fluid from all, or substantially all, directions. An advantage of showering the debris particulates with fluid from all directions is the ability to surround, capture or otherwise encapsulate fine particulates with the fluid droplets, such that these particulates are contained within the fluid, in the vacuum canister, and are removed from the airflow and exhaust.

The airflow carries the debris through the outlet port 310 and into the user's vacuum intake. As the debris is flowing through the outlet port 310, a user has the ability to view the flow through the view window 330. An advantage of the window 330 is that it allows the user to view the debris flow to determine if the fluid flow rate that is exiting from the collar 306 needs to be adjusted.

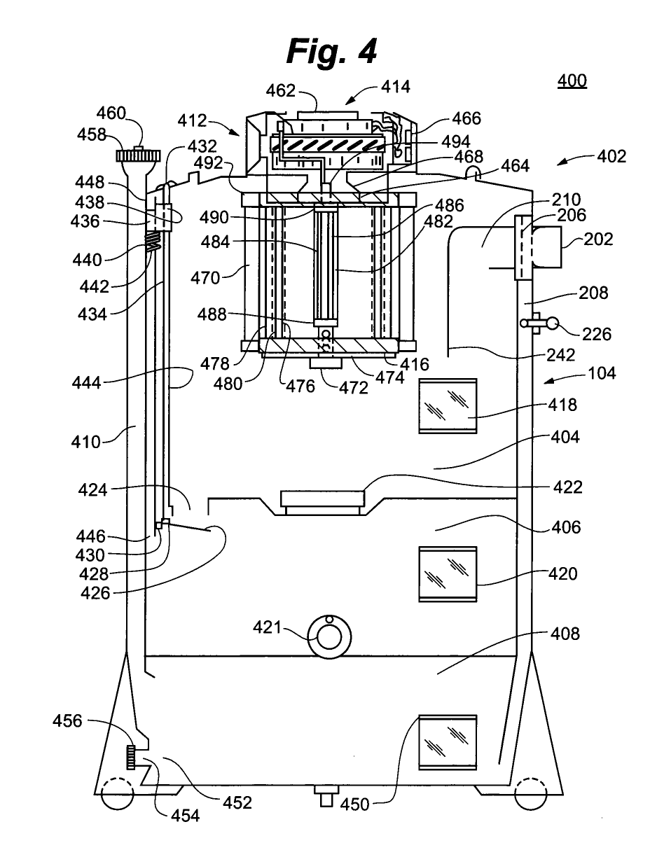

FIG. 4 is a perspective view of an embodiment of a hydro-infusion wet/dry debris containment system unit 400, including an ionic generator and multiple tanks The unit 400 comprises at least a debris intake system 402, a debris chamber 404, a first tank 406, a second tank 408, a fluid fill port 410, a housing for mechanical components 412, an exhaust port 414, and an ionic generator 416. The debris intake system 402, includes, as more fully discussed above in FIG. 2, a debris inlet port 202, a fluid collar 206, a fluid inlet 208, a regulator 226, a debris outlet port 210, and a back plate 242.

The debris chamber 404 can be disposed in an upper portion of the canister 104, wherein the bottom surface of the debris chamber 404 is also the top surface of the first tank 406, as discussed more fully below. The debris chamber 404 can comprise a view window 418, such that a user may view the contents of the debris chamber 404. The first tank 406 can be disposed in a lower portion of the unit such that the first tank 406 is disposed between the debris chamber 404 and the second tank 408. The first tank 406 can also comprise a view window 420, such that the user may view the contents and/or fluid level of the first tank 406. The first tank 406 can further consist of a drain valve 421 providing the user with way of emptying the contents from the first tank 406. The first tank 406 can also consist of a covered access 422, such that the access 422 is a protrusion from the first tank 406 into the debris chamber 404, wherein the protrusion consists of male threading such that a female threaded cover can be coupled onto the protrusion.

The debris chamber 404 and the first tank 406 may have a communication port 424, such that when the debris chamber 404 becomes full, the contents in the debris chamber 404 can be sucked into the first tank 406, through the use of a vacuum. The communication port 424 can comprise a beveled trap door 426, a trap door pivot connector 428, and a trap door hinge 430. The communication port 424 can be operated by a push button 432 or other actuator that is operatively connected to a vertical push rod 434 through the use of a vertical push rod control collar and guide 436, a connector 438, a tension spring 440, and a tension spring stop 442. The push rod 434 can be located within and held in place by a molded cover 444. An air vent 446 comprising a tubular member extends from the first tank 406 to the top of the canister 104 and includes a breather hole 448 at the top, wherein as the contents of the debris chamber 404 are deposited into the first tank 406, the displaced air can escape through the air vent 446 and breather hole 448.

The second tank 408 can be disposed in the bottom portion of the canister 104 below the debris chamber 404 and the first tank 406. The second tank 408 can also comprise a view window 450, such that a user is able to view the fluid level of the tank 408 for use in the debris intake system 402. The second tank 408 can comprise a drain port 452, such that the fluid in the second tank 408 can be easily drained out of the second tank 408. The drain port 452 can consist of a protrusion 454 and cap 456, such that the protrusion may have male threading and the cover may have female threading wherein the cover can be coupled to the protrusion. Alternatively, the cap can snap onto the protrusion. There are other means by which to provide for easy drainage of the second tank 408, such as a spigot and the like.

The fluid fill port 410 can be a tubular member that extends the vertical length of the unit, wherein the top end of the fluid fill port 410 extends just beyond the top surface of the unit and the bottom end of the fluid fill port 410 terminates into the second tank 408. The top end of the fluid fill port 410 may be such that it has male threading such that a cover 458, having female threading can be screwed onto the top end of the fluid fill port 408. Alternatively, a cover can be snapped onto the top end of the fluid fill port. The cover 458 can also have a breather inlet 460, such that as the fluid is being sucked up by the vacuum for use in the debris intake system 402, the pressure inside the tank 408 can be equalized.

The housing 412 can be located at the top of the unit, wherein the housing 412 houses at least a motor, fan, an exhaust port filter 462, an exhaust port 414, an on/off switch 464, and a warning light 466.

The ionic generator 416 can be disposed such that it is in communication with the mechanical housing 412 in the upper portion of the unit 400 through the induction vacuum throat 468. The ionic generator 416 can also be covered/surrounded by a filter 470. The ionic generator 416 can comprise the following components: a thumb screw 472, an anode metallic holding plate 474, outer copper screens 476, 478, outer stainless steel screen 480, inner copper screens 482, 484, 486, rubber insulators 488, 490, rubber filter collar 492, and a ground contact terminal screw 494.

In operation this unit combines the debris intake system 402 with an ionic generator 416 to capture/encapsulate fine particulates from within the airflow, such that they are not returned back into the environment. As more fully described with respect to FIG. 2 above, the debris enters with the air flow through the debris intake system 402 where the debris is lifted to the center, or almost center, of the air flow before entering the expansion chamber where the debris and air flow move through a curtain of fluid. The curtain of fluid emanates from a plurality of orifices located in a fluid collar, which is in communication with a fluid inlet, which is in fluid communication with a tank 408 located in the canister unit 400.

After the airflow carries the debris through the expansion chamber into the outlet port 201 and against the back plate 242, the airflow continues into the debris chamber 404. Due to gravity the bigger pieces of debris will fall out of the airflow and into the debris chamber 404, where the user can look through a view window 418 to determine if the debris chamber 404 has reached capacity. Particulates that were encapsulated by fluid from the fluid curtain may collect along the surface of the back plate 242 until such time as the collection weight overcomes the surface friction and the collection of debris also falls into the debris chamber 404.

The airflow then moves upward through the paper filter 470 surrounding the ionic generator 416, through the ionic generator 416, through the induction vacuum intake 468 past the exhaust fan, exhaust filter then out the exhaust port, and back into the environment. As the airflow moves through the filter 470 if any particulates still remain the filter can capture such particulates as the filter is designed to capture. Therefore, depending on the filter, very fine particulates may yet pass through the filter 470 and into the passive ionic generator 416.

The passive ionic generator 416 has concentric rings of dissimilar metal screens attached to an anode metallic base. The outer copper screens 476, 478 and outer stainless steel screen 480 generate negative ions. A metallic collar may be insulated between the metal screens and the cartridge filter connecting post and grounded to the electric motor. Any particulates that are not removed from the debris path by the fluid infusion, pass through the ionic generator receiving a positive charge and are likely attracted to the grounded collar. As the positive dust and allergen airborne particulates pass through the outer screens 476, 478, 480, they join with the negative ions and become heavy, falling out of the airflow and collecting in the base plate 474 of the ionic generator 416. A thumbscrew 472 allows the user to remove the screw 472 and take down the base plate for cleaning purposes. After the airflow moves through the ionic generator 416, the airflow continues upward through the fan, the exhaust filter, exhaust port 414, and back into the environment.

The filter 470 surrounding the ionic generator 416 can be held frictionally in place by rubber filter collar 492 as it sits inside the cartridge filter 470. This allows the user the ability to also change and clean out the filter 470 as the filter 470 and rubber filter collar 492 can be pulled off from surrounding the ionic generator 416. After cleaning and/or replacing the filter 470, the filter 470 and rubber filter collar 492 can be slid back into place around the outside surface of the ionic generator 416.

Another feature of this unit 400, is the ability of the user to, while using the vacuum, have additional debris containment. For example, the user has a large amount of wet debris the user wishes to collect. After the user has turned on the unit 400 and filled the debris chamber 404, a user can push a button 432, or other actuator, causing a trap door, for example, to open in the bottom of the debris chamber 404 into an open tank 406. Once the door has been opened and because the vacuum is on creating suction, the contents of the debris chamber 404 are sucked into the tank 406. Once the contents are displaced into the tank 406, the user can release the button 432, the trap door with shut and the user can continue collect debris, which debris will accumulate in the debris chamber 404.

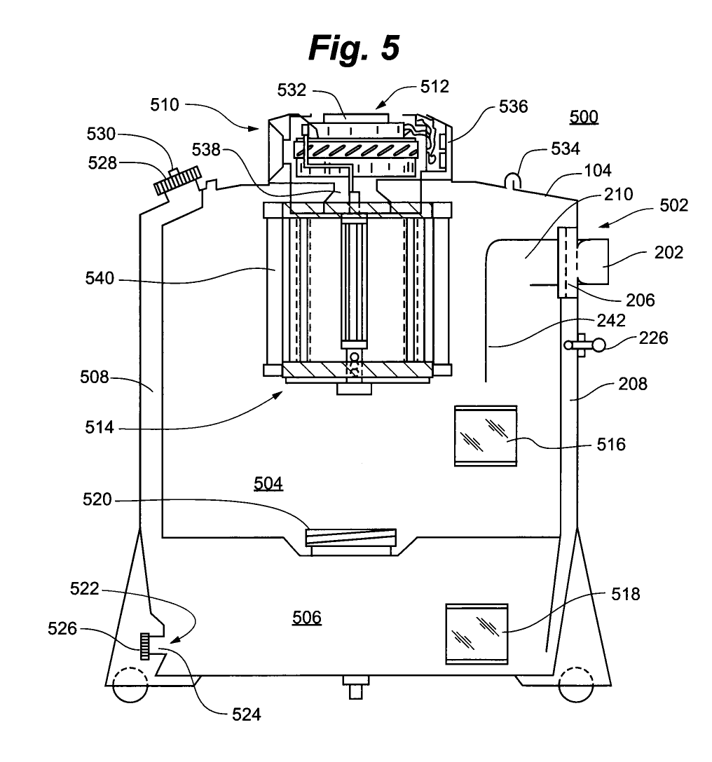

FIG. 5 is a perspective view of an embodiment of a hydro-infusion wet/dry debris containment system unit 500, including an ionic generator. The unit 500 comprises at least a debris intake system 502, a debris chamber 504, a tank 506, a fluid fill port 508, a housing for mechanical components 510, an exhaust port 512, and an ionic generator 514. The debris intake system 502, includes, as more fully discussed above in FIG. 2, a debris inlet port 202, a fluid collar 206, a fluid inlet 208, a regulator 226, a debris outlet port 210, and a back plate 242.

The debris chamber 504 can be disposed in an upper portion of the canister 104, wherein the bottom surface of the debris chamber 504 is also the top surface of the tank 506, as discussed more fully below. The debris chamber 504 can comprise a view window 516, such that a user may view the contents of the debris chamber 504. The tank 506 can be disposed in a lower portion of the unit such that the bottom surface of the tank 506 is also the bottom surface of the canister 104. The tank 506 can also comprise a view window 518, such that the user may view the contents and/or fluid level of the tank 506. The tank 506 can also consist of a covered access 520, such that the access 520 is a protrusion from the tank 506 into the debris chamber 504, wherein the protrusion consists of male threading such that a female threaded cover can be coupled onto the protrusion.

The tank 506 can comprise a drain port 522, such that the fluid in the tank 506 can be easily drained out of the tank 506. The drain port 522 can consist of a protrusion 524 and cap 526, such that the protrusion may have male threading and the cover may have female threading wherein the cover can be coupled to the protrusion. Alternatively, the cap can snap onto the protrusion. There are other means by which to provide for easy drainage of the tank 506, such as a spigot and the like.

The fluid fill port 508 can be a tubular member that extends the vertical length of the unit, wherein the top end of the fluid fill port 508 extends just beyond the top surface of the unit and the bottom end of the fluid fill port 508 terminates into the tank 506. The top end of the fluid fill port 508 may be such that it has male threading such that a cover 528, having female threading can be screwed onto the top end of the fluid fill port 508. Alternatively, a cover can be snapped onto the top end of the fluid fill port 508. The cover 528 can also have a breather inlet 530, such that as the fluid is being sucked up by the vacuum for use in the debris intake system 502, the pressure inside the tank 506 can be equalized.

The housing 510 can be located at the top of the unit, wherein the housing 510 houses at least a motor, fan, an exhaust port filter 532, an exhaust port 512, an on/off switch 534, and a warning light 536.

The ionic generator 514 can be disposed such that it is in communication with the mechanical housing 510 in the upper portion of the unit 500 through the induction vacuum throat 538. The ionic generator 514 can also be covered/surrounded by a filter 540. The ionic generator 514 can comprise components similar to those as more fully described above in FIG. 4.

In operation, unit 500 combines the debris intake system 502 with an ionic generator 514 to capture/encapsulate fine particulates from within the airflow, such that they are not returned back into the environment. As more fully described with respect to FIG. 2 above, the debris enters with the air flow through the debris intake system 502 where the debris is lifted to the center, or almost center, of the air flow before entering the expansion chamber where the debris and air flow move through a curtain of fluid. The curtain of fluid emanates from a plurality of orifices located in a fluid collar, which is in communication with a fluid inlet, which is in fluid communication with a tank 506 located in the canister unit 500.

After the airflow carries the debris through the expansion chamber into the outlet port 201 and against the back plate 242, the airflow continues into the debris chamber 504. Due to gravity the bigger pieces of debris will fall out of the airflow and into the debris chamber 504, where the user can look through a view window 516 to determine if the debris chamber 504 has reached capacity. Particulates that were encapsulated by fluid from the fluid curtain may collect along the surface of the back plate 242 until such time as the collection weight overcomes the surface friction and the collection of debris also falls into the debris chamber 504.

The airflow then moves upward through the paper filter 540 surrounding the ionic generator 514, through the ionic generator 514, through the induction vacuum intake 542 passed the exhaust fan, exhaust filter then out the exhaust port 512, and back into the environment. As the airflow moves through the filter 540 if any particulates still remain the filter can capture such particulates as the filter is designed to capture. Therefore, depending on the filter, very fine particulates may yet pass through the filter 540 and into the ionic generator 514. The ionic generator 514, as described more fully above in FIG. 4, aids in the capture of very fine particulates still existing in the airflow stream. After the airflow moves through the ionic generator 514, the airflow continues upward through the fan, the exhaust filter, exhaust port 512, and back into the environment.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, feature locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

What is claimed is:

1. A hydro-infusion wet/dry debris containment system unit, comprising
a canister,
at least one debris intake system comprising a debris inlet port, an expansion chamber, a fluid collar, a fluid inlet, and a debris outlet port,
the debris inlet port comprising a distal end, a proximal end, a intermediate section disposed therebetween and a lumen therethough having a wall with a smoothly varying diameter for generating a venturi effect within the lumen, wherein the lumen diameter at the distal end is smaller than the lumen diameter at the proximal end, and
the fluid collar comprising a plurality of orifices,
a curtain of water generated by the plurality of orifices,
at least one debris chamber in fluid communication with the at least one debris intake system,
at least one filter in fluid communication with the at least one debris chamber,
at least one tank in fluid communication with the at least one debris intake system,
at least one electric motor assembly, wherein said assembly powers and creates suction within the unit,
at least one fluid fill port in fluid communication with the at least one tank, and
at least one exhaust port in fluid communication with at least one filter,
wherein debris is sucked into the debris inlet port and is lifted away from the lumen wall by a venturi effect caused by airflow across the smoothly varying diameter of the lumen wall.

2. The unit of claim 1, further comprising a view window.

3. The unit of claim 1, further comprising an ionic generator.

4. The unit of claim 1, further comprising a regulator, wherein the regulator adjusts the flow of fluid between the tank and the collar.

5. The unit of claim 1, further comprising additional tanks.

6. The unit of claim 5, wherein the additional tanks may be separate pieces that can be attached to the unit.

7. A hydro-infusion wet/dry debris containment system adaptor, comprising
at least one debris intake system comprising a debris inlet port, an expansion chamber, a fluid collar, a fluid inlet, and a debris outlet port,
the debris inlet port comprising a distal end, a proximal end, a intermediate section disposed therebetween and a lumen therethough having a wall with a smoothly varying diameter for generating a venturi effect within the lumen, wherein the lumen diameter at the distal end is smaller than the lumen diameter at the proximal end, and
the fluid collar comprising a plurality of orifices,
a curtain of water generated by the plurality of orifices,
at least one reservoir in fluid communication with the at least one debris intake system, and
at least one fluid inlet port in fluid communication with the at least one reservoir and at least one fluid collar,
wherein debris is sucked into the debris inlet port and is lifted away from the lumen wall by a venturi effect caused by airflow across the smoothly varying diameter of the lumen wall.

8. The adaptor of claim 7, wherein the collar engages with the expansion chamber.

9. The adaptor of claim 7, further comprising a regulator, wherein the regulator varies the flow of fluid from the reservoir to the collar.

10. The adaptor of claim 7, wherein the adaptor is separate pieces.

11. The adaptor of claim 7, further comprising an adaptor to vary the size of the internal diameters of the inlet port, the outlet port, the fluid inlet port, and any combination thereof.

12. A method of encapsulating particulates through a debris intake system, comprising:
providing a hydro-infusion wet/dry debris containment system unit, comprising;
a canister,
at least one debris intake system comprising a debris inlet port, an expansion chamber, a fluid collar, a fluid inlet, and a debris outlet port,
the debris inlet port comprising a distal end, a proximal end, a intermediate section disposed therebetween and a lumen therethough having a wall with a smoothly varying diameter for generating a venturi effect within the lumen, wherein the lumen diameter at the distal end is smaller than the lumen diameter at the proximal end, and
the fluid collar comprising a plurality of orifices,
a curtain of water generated by the plurality of orifices,
at least one debris chamber in fluid communication with the at least one debris intake system,
at least one filter in fluid communication with the at least one debris chamber,
at least one tank in fluid communication with the at least one debris intake system,
at least one electric motor assembly, wherein said assembly powers and creates suction within the unit,
at least one fluid fill port in fluid communication with the at least one tank, and
at least one exhaust port in fluid communication with at least one filter,
sucking up debris into the debris inlet port,
causing the debris to be lifted to the center of the airflow path as the debris inlet port's internal surface slopes toward the distal end of the debris intake system,
separating the debris as the debris passes through the distal end of the debris intake system and into the expansion chamber,
using the vacuum's power to suck up fluid into the fluid collar,
spraying the debris with the fluid as it passes through the fluid collar by the plurality of orifices,
encapsulating the debris with the fluid, and
expelling the encapsulated debris through the outlet port.
